(19) United States
(12) Patent Application Publication
(10) Pub. No.: US 2002/0123998 A1
(43) Pub. Date: Sep. 5, 2002

(54) Data transmission system involving a server, station suitable for such a system and method of downloading data

(76) Inventors: Pascal Breut, Le Mans (FR); Philippe Thauvin, Arnage (FR)

Correspondence Address: Philips Electronics North America Corporation, 580 White Plains Road, Tarrytown, NY, 10591, US

(21) Appl. No.: 09/995,437

(22) Filed: Nov. 27, 2001

(30) Foreign Application Priority Data
Nov. 30, 2000 (FR) 0015536

(51) Int. Cl. G06F 7/00

(52) U.S. Cl. 707/9

(57) ABSTRACT

This data transmission system is formed by at least a mobile radio station (1) including a site explorer (2) and by at least a WAP data server (20) that concludes a list of names of accessible files (24). To these names of accessible files is associated an URL address which defines:

a preparation of the activation of said station for an application (dev),

an application (appli. xxx),

an IP address for defining the address of the server of the accessible file (Iphx),

the name of the accessible file (filnamex),

the possible parameters for this file (parameter).

The invention does not have the constraints of filter devices of the Internet world, so that files for a mobile WAP can be accessed via the Internet.

Application: WAP navigation.

The invention relates to a data transmission system formed by at least a station that includes a site explorer and by at least a data server that includes an access file that gives a list of names of accessible files.

The invention also relates to a station suitable for such a system.

The invention further relates to a data downloading method used in such a system.

The invention finds interesting applications notably in the field of mobile radio telephony devices using the possibilities of the WAP protocol (Wireless Application Protocol). Any indications about this protocol will be found on the following Internet site: http://www.wapforum.org.

Or, more precisely, at: http://www.wapforum.org/what/copyright.htm.

This protocol enables to download various objects of a server, for example, songs, <<jpeg>> images, icons, game scenarios, VGX films (see the patent document filed in Great Britain under no. 0013764.6 on 07.06.2000), update software for the operation of the mobile device, software of applications such as an organizer, editor, etc. and also sound files such as MP3.

The problem that occurs in this type of application is that the data server is situated in the Internet world, whereas the mobile radiophone device is, in principle, served by the WAP network. In this WAP network there is a filter device that filters the requests coming from all the mobile radio devices that are connected thereto. Thus it may happen that a request is not satisfied.

The present invention proposes a system of the type mentioned in the opening paragraph, which enables to access files of the Internet world in a compatible way with the filter systems of this world.

Therefore, such a system is characterized in that an URL address is associated to at least one of said accessible file names, which address defines:

a preparation of the activation of said station for an application (devi), an application (appli. xxx),

an IP address for defining the address of the server of the accessible file,

the name of the accessible file,

the possible parameters for this file.

The idea of the invention thus consists of the use of a special address format that permits at filter device level to define the requests to be satisfied.

These and other aspects of the invention are apparent from and will be elucidated, by way of non-limitative example, with reference to the embodiment(s) described hereinafter.

In the drawings:

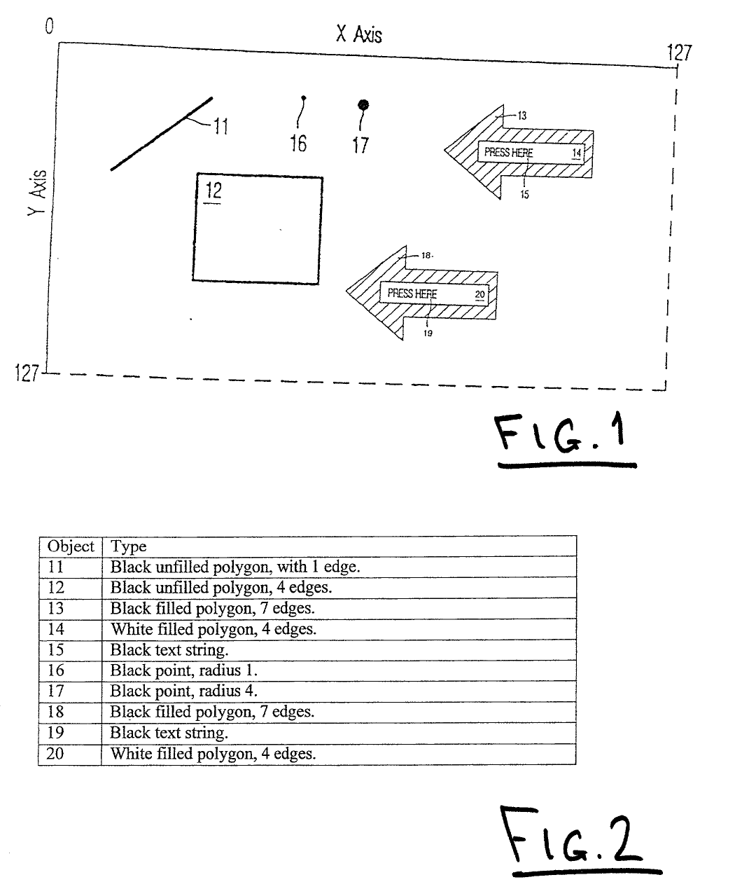

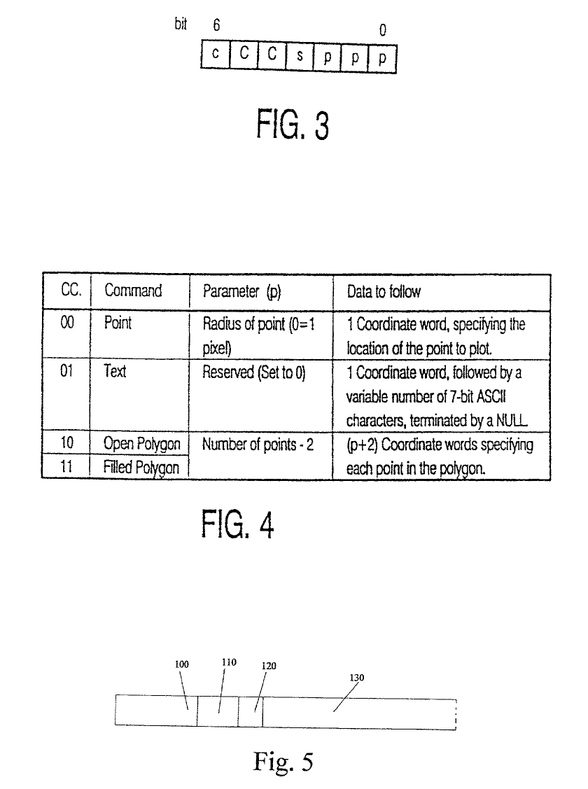

FIG. 1 shows a system according to the invention,

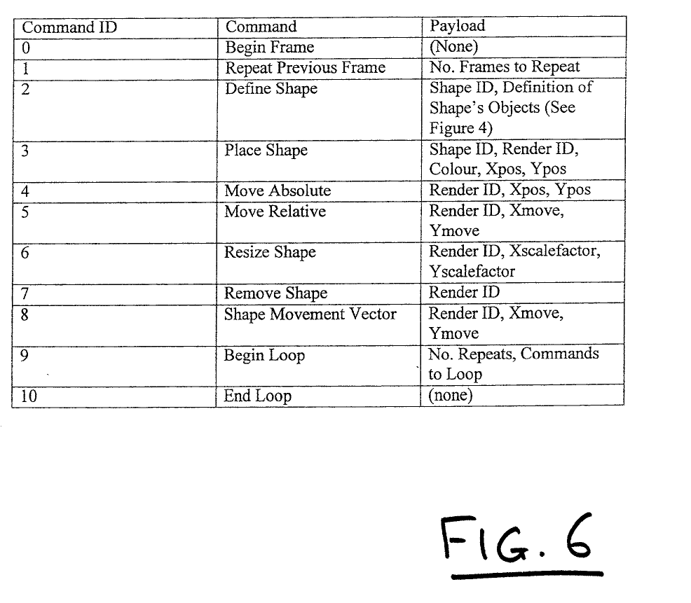

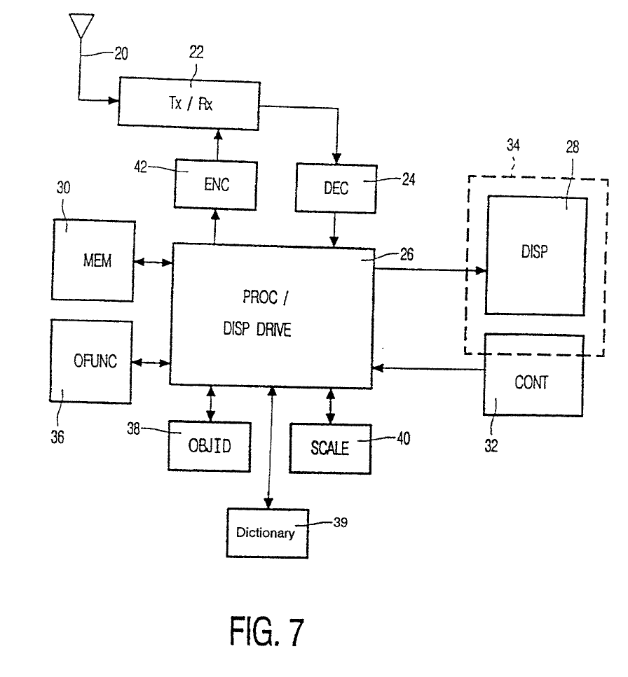

FIG. 2 shows the organization of a consultation page according to the invention.

FIG. 1 represents a system in accordance with the invention. Reference 1 indicates a mobile telephony station including means for effecting traffic according to said WAP standard. For this purpose, the mobile station 1 includes a WAP navigator 2 and other utility programs among which, inter alia, a file transfer program 3 that meets the security standard [TFTP].

Obviously, although for clarity a single station is shown in FIG. 1, the system comprises a multitude thereof. This station 1 is connected to the mobile radio network 5. This network permits a link to a WAP server 20 which forms part of the services assembly 10 belonging to the operator, for example, network manager 5. This assembly includes a connection device 12 to which in the first place the station 1 is connected and ensures the usual signal interface. A router 14 enables to route the various requests formulated by mobile stations connected to the network. At the level of this router 14 an IP link (Internet Protocol), assigned to the station 1, is created. Certain requests are analyzed by a <<firewall>> filter device 16. Others are sent elsewhere. The device 16 rejects all the requests whose port does not correspond to one of those recorded in list 18. The admitted requests may then be directed to the WAP server 20 while passing through the access device (gateway 22). On the server 20 may be found a page written in the WML language. This server 20 may give access to a server 24 for downloading tftp files that correspond to the above-mentioned tftp program.

It is also possible to be connected to other WAP sites, which do not form part of the system of the operator. In FIG. 1 is represented by reference 40 another WAP-oriented site including, inter alia, a WAP server 42 to which are connected notably a filter device 44 and a tftp server 46. It is also possible to access servers by using the Internet referred to as 50 in the Figure.

According to the invention one has pages which are preferably WML pages at the WAP server 20, and which contain the file addresses that may be used by the mobile station 1 and modified in accordance with the measures of the invention.

FIG. 2 shows how a page is organized. To each file whose name is given in a column 30 is associated an URL address which is shown in another column 32 for clarity but, in fact, need not of necessity be visible to the user. This address is formed in the following manner:

Dev: appli. xxx.IPhost: <<file name>>: param in this address:

Dev: is the preamble of the address, in practice this is <<device>> which indicates that the application whose name fits is to be loaded at the mobile station 1.

Appli. xxx: specifies that an application is requested and is to be loaded. The name of the application is given by <<xxx>>, for example, if xxx =tftp, in that case the application tftp will be loaded in the mobile station 1.

IPhost gives the IP address of the server on which the file indicated hereinafter is placed.

<<file name>>: gives the name of the desired file

Param: is the list of the parameters for the desired file or application.

Another measure of the invention consists of complementing the port of the application at the filter device. This is indicated in FIG. 1 by the reference: p(tftp) in the column Prt. The other ports that are indicated correspond to the various phases or the various connection modes of the mobile station.

The operation of the invention is explained for the following cases:

A—downloading a file

One places oneself in the case where one wishes to download the file 52. This file 52 is placed on the hard disk of the server which forms site 24. This server 24 is an FTP server (File Transfer Protocol).

1) The user influences his WAP navigator and explores the WAP site 20. He consults page 25, which gives the file reference 52.

2) This page 25, with the URL addresses defined above, is downloaded to the mobile station 1.

3) With the aid of his explorer 2 the user chooses one of the files that are presented to him: for example, as shown in FIG. 2, the file whose name is: <<FILE2>>.

4) As the characters <<tftp>> situated after <<appli>> are decoded, the address of the column 32 with respect to this “FILE2” is delivered to the application that manages this tftp protocol.

5) The application that manages tftp starts a session for the IP addressing given in the URL address defined by the invention for requesting the transfer of the file.

6) The router 14 receives this request, which is accompanied by the IP address in accordance with the invention and addresses it directly to the server 24. Thus the transfer of the desired file is made in the direction of the mobile station 1.

7) The station 1 receives the header of the load, which starts the writing of the file inside the mobile.

8) Any application contained in the station can thus use the file transmitted in this way.

Obviously, if the file is a file 60 situated in the site 40, the file will be accessed and transferred while the Internet 50 is made use of.

B—Downloading executable files

The process is the same as that described above. However, there is one difference that comes from the contents of the file. This time this is not a file that is to be interpreted, but a list of instructions that are to be executed by the processor. A possible variant consists of transmitting this file in compressed form.

C—Production of music or voice sounds during a WAP session

In this system the downloading mechanism is similar to the mechanism that has already been seen. The difference comes from the fact that the station is to use the file during the downloading.

1. A data transmission system formed by at least a station that includes a site explorer and by at least a data server that includes an access file that gives a list of names of accessible files, characterized in that an URL address is associated to at least one of said accessible file names, which address defines:
a preparation of the activation of said station for an application (devi),
an application (appl. xxx),
an IP address for defining the address of the server of the accessible file,
the name of the accessible file,
the possible parameters for this file.

2. A transmission system as claimed in claim 1, in which the server includes a firewall that selects requests which include indications of ports contained in a list of permitted ports, characterized in that the ports of said applications are inserted into the list of the ports permitted by said firewall.

3. A transmission system as claimed in claim 1 or 2, characterized in that it is adapted to the WAP system.

4. A station suitable for a system as claimed in one of the claims 1 or 2 or 3, characterized in that it includes a site explorer and means for activating the applications as a function of said address.

5. A station as claimed in claim 4, characterized in that said explorer corresponds to the WAP system.

6. A method of transmitting data implying a data server and a station requesting data from said server utilized in a system as claimed in one of the claims 1 to 3, characterized in that it includes the following steps:
activating the site explorer of the station,
connection to a site via a firewall,
access to an access file with transfer in said station,
starting an application defined by an address code associated to a name given by said access file as a function of the user's choice,
access to the file determined by said address code while utilizing the address also given by said address code,
starting said application.
